(19) United States
(12) Patent Application Publication
(10) Pub. No.: US 2019/0005554 A1
(43) Pub. Date: Jan. 3, 2019

(54) OPTIMAL SIZING OF ENERGY STORAGE UNITS IN DEMAND CHARGE MANAGEMENT AND PV UTILIZATION APPLICATIONS

(71) Applicant: NEC Laboratories America, Inc., Princeton, NJ (US)

(72) Inventors: Babak Asghari, San Jose, CA (US); Ratnesh Sharma, Fremont, CA (US); Mohammad Rasoul Narimani, Rolla, MO (US)

(21) Appl. No.: 15/992,955

(22) Filed: May 30, 2018

Related U.S. Application Data
(60) Provisional application No. 62/525,848, filed on Jun. 28, 2017.

(51) Int. Cl. G06Q 30/02; G05B 15/02; G06Q 50/06

(52) U.S. Cl. CPC G06Q 30/0283; G06Q 50/06; G05B 15/02

(57) ABSTRACT

A system, method, and computer-program product are provided for controlling a distributed energy storage system (ESS) operatively coupled to one or more microgrids. The system includes a memory for storing program code. The system further includes a processor for running the program code to respectively assign a first, a second, and a third set of weights to a first, a second, and a third objective function formulated to minimize an ESS cost, minimize a Demand Charge (DC) cost, and maximize a Photovoltaic utilization, respectively. The processor further runs the program code to execute a multi-objective ESS optimizing engine to obtain a set of different monthly-based optimal solutions for controlling the ESS by concurrently processing the first, the second, and the third objective functions using different ones of the weights from the first, the second, and the third set of weights.

### RELATED APPLICATION INFORMATION

This application claims priority to provisional application Ser. No. 62/525,848 filed on Jun. 28, 2017, incorporated herein by reference.

### BACKGROUND

### Technical Field

The present invention relates to energy systems, and more particularly to optimal sizing of energy storage units in demand charge management and PV utilization applications.

### Description of the Related Art

Behind-The-Meter (BTM) Energy Storages Systems (ESSs) can provide a range of benefits to electricity consumers and distribution system operators. ESSs have recently come under spotlight as a possible means to reduce the electricity cost of Commercial and Industrial (C&I) buildings by reducing peak demand (Demand Charge (DC) management). ESSs can also store excess generation of distributed energy resources for future consumption by the users. Due to their high cost, it is important to determine optimal energy and power capacity of these units to maximize the return on investment. Hence, there is a need for an approach for optimal sizing of energy storage units in demand charge management and PV utilization applications.

### SUMMARY

According to an aspect of the present invention, a system is provided for controlling a distributed energy storage system (ESS) operatively coupled to one or more microgrids. The system includes a memory for storing program code. The system further includes a processor for running the program code to respectively assign a first, a second, and a third set of weights to a first, a second, and a third objective function formulated to minimize an ESS cost, minimize a Demand Charge (DC) cost, and maximize a Photovoltaic utilization, respectively. The processor further runs the program code to execute a multi-objective ESS optimizing engine to obtain a set of different monthly-based optimal solutions for controlling the ESS by concurrently processing the first, the second, and the third objective functions using different ones of the weights from the first, the second, and the third set of weights.

According to another aspect of the present invention, a computer-implemented method is provided for controlling a distributed energy storage system (ESS) operatively coupled to one or more microgrids. The method includes respectively assigning by a processor, a first, a second, and a third set of weights to a first, a second, and a third objective function formulated to minimize an ESS cost, minimize a Demand Charge (DC) cost, and maximize a Photovoltaic utilization, respectively. The method further includes executing, by the processor, a multi-objective ESS optimizing engine to obtain a set of different monthly-based optimal solutions for controlling the ESS by concurrently processing the first, the second, and the third objective functions using different ones of the weights from the first, the second, and the third set of weights.

According to yet another aspect of the present invention, a computer program product is provided for controlling a distributed energy storage system (ESS) operatively coupled to one or more microgrids. The computer program product includes a non-transitory computer readable storage medium having program instructions embodied therewith. The program instructions are executable by a computer to cause the computer to perform a method. The method includes respectively assigning, by a processor of the computer, a first, a second, and a third set of weights to a first, a second, and a third objective function formulated to minimize an ESS cost, minimize a Demand Charge (DC) cost, and maximize a Photovoltaic utilization, respectively. The method further includes executing, by the processor, a multi-objective ESS optimizing engine to obtain a set of different monthly-based optimal solutions for controlling the ESS by concurrently processing the first, the second, and the third objective functions using different ones of the weights from the first, the second, and the third set of weights.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block diagram showing an exemplary processing system to which the present invention may be applied, in accordance with an embodiment of the present invention;

FIG. 2 is a block diagram showing an exemplary environment to which the present invention can be applied, in accordance with an embodiment of the present invention;

FIG. 3 is a flow diagram showing an exemplary method for optimal sizing of energy storage units in demand charge management and PV utilization applications, in accordance with an embodiment of the present invention;

FIG. 4 is a flow diagram further showing a block of FIG. 3, in accordance with an embodiment of the present invention;

FIG. 5 is a flow diagram further showing a block of FIG. 4, in accordance with an embodiment of the present invention;

FIG. 6 is a flow diagram an exemplary method for multi-objective optimization for ESS cost, DC cost, and PV utilization, in accordance with an embodiment of the present invention;

FIG. 7 is a flow diagram showing an exemplary method for mapping to morph results from a monthly horizon to a yearly horizon, in accordance with an embodiment of the present invention; and

FIG. 8 is a high-level block diagram showing a decision making model for selecting a best compromise solution, in accordance with an embodiment of the present invention.

### DETAILED DESCRIPTION OF PREFERRED EMBODIMENTS

The present invention is directed to optimal sizing of energy storage units in demand charge management and PV utilization applications.

The present invention can solve the multi-objective optimization problem of how to determine the most economic ESS to minimize peak demand and maximize the demand charge savings as well as the PV utilization.

In an embodiment, the present invention applies a weighted sum method to solve the multi-objective optimization problem to optimize the ESS cost, DC cost and PV utilization at the same time. A linear cost function has been derived for an ESS based on the power and capacity of the ESS in order to obtain the most economic combination for the ESS. The problem has been solved in different time horizons and the results have been mapped into a unique time horizon, in order to preserve the inherit characteristic of each objective function. The solution methodology leads to obtaining different non dominated optimal solutions in which the user can select one. A decision making process has been proposed for selecting the best compromise solution by user.

In an embodiment, the present invention obtains the most economic ESS in order to reduce the DC cost, a substantial portion of an electricity bill, and increase the PV utilization. Reducing the DC cost helps a user to decrease their electricity bills and save money while increasing the PV utilization decreases the energy losses in distribution networks, and mitigates overvoltage and transformer overloading. These and other benefits and advantages of the present invention are readily apparent to one of ordinary skill in the art given the teachings of the present invention provided herein, while maintaining the spirit of the present invention.

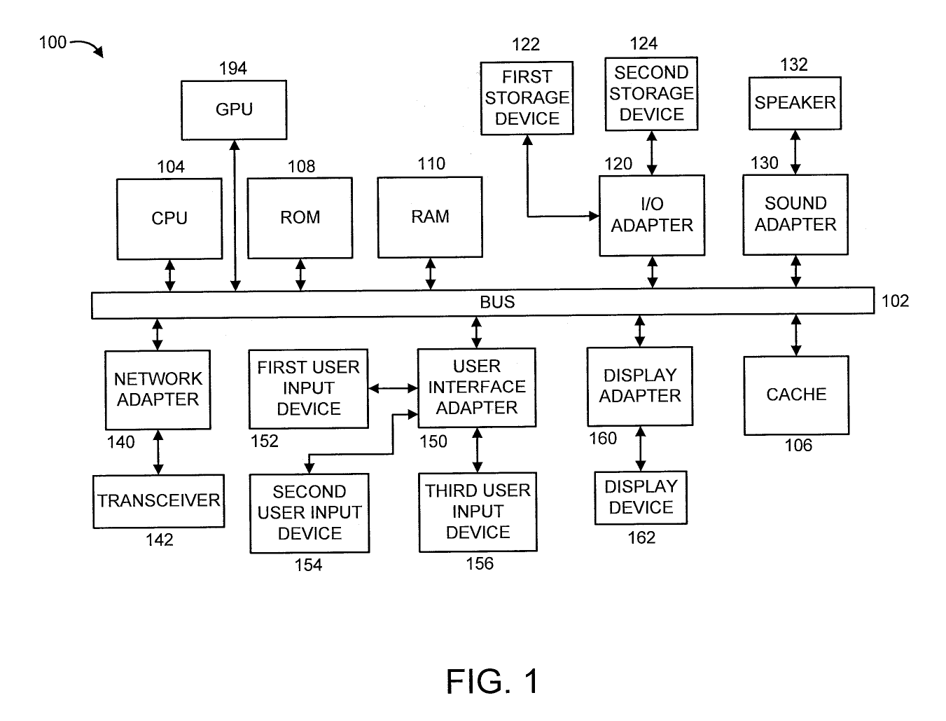

FIG. 1 is a block diagram showing an exemplary processing system 100 to which the invention principles may be applied, in accordance with an embodiment of the present invention. The processing system 100 includes at least one processor (CPU) 104 operatively coupled to other components via a system bus 102. A cache 106, a Read Only Memory (ROM) 108, a Random Access Memory (RAM) 110, an input/output (I/O) adapter 120, a sound adapter 130, a network adapter 140, a user interface adapter 150, and a display adapter 160, are operatively coupled to the system bus 102. At least one Graphics Processing Unit (GPU) 194 is operatively coupled to the system bus 102.

A first storage device 122 and a second storage device 124 are operatively coupled to system bus 102 by the I/O adapter 120. The storage devices 122 and 124 can be any of a disk storage device (e.g., a magnetic or optical disk storage device), a solid state magnetic device, and so forth. The storage devices 122 and 124 can be the same type of storage device or different types of storage devices.

A speaker 132 is operatively coupled to system bus 102 by the sound adapter 130. A transceiver 142 is operatively coupled to system bus 102 by network adapter 140. A display device 162 is operatively coupled to system bus 102 by display adapter 160.

A first user input device 152, a second user input device 154, and a third user input device 156 are operatively coupled to system bus 102 by user interface adapter 150. The user input devices 152, 154, and 156 can be any of a keyboard, a mouse, a keypad, an image capture device, a motion sensing device, a microphone, a device incorporating the functionality of at least two of the preceding devices, and so forth. Of course, other types of input devices can also be used, while maintaining the spirit of the present invention. The user input devices 152, 154, and 156 can be the same type of user input device or different types of user input devices. The user input devices 152, 154, and 156 are used to input and output information to and from system 100.

Of course, the processing system 100 may also include other elements (not shown), as readily contemplated by one of skill in the art, as well as omit certain elements. For example, various other input devices and/or output devices can be included in processing system 100, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system 100 are readily contemplated by one of ordinary skill in the art given the teachings of the present invention provided herein.

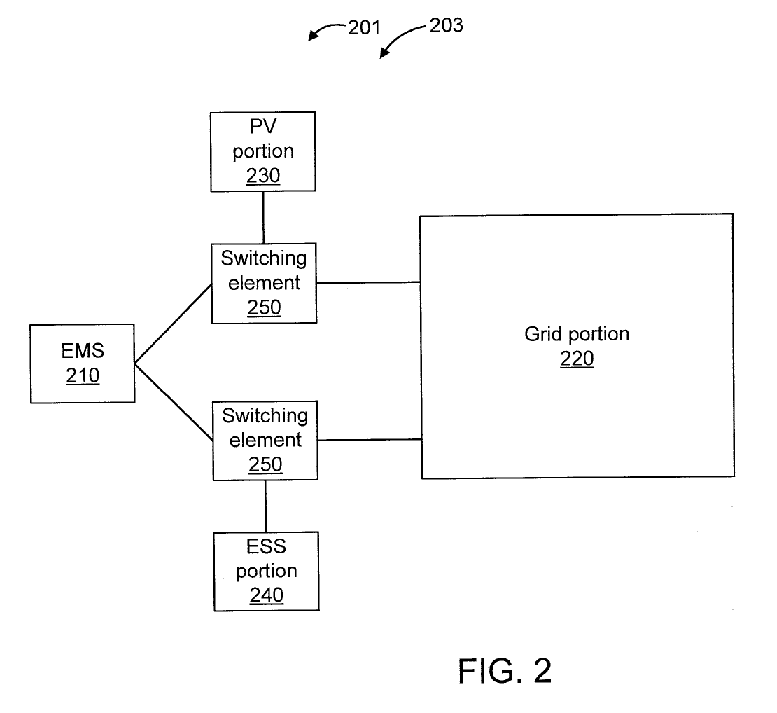

Moreover, it is to be appreciated that architecture 200 described below with respect to FIG. 2 is an architecture for implementing respective embodiments of the present invention. Part or all of processing system 100 may be implemented in one or more of the elements of architecture 200.

Further, it is to be appreciated that processing system 100 may perform at least part of any of the methods described herein. Similarly, part or all of architecture 200 may be used to perform at least part of any of the methods described herein.

FIG. 2 is a block diagram showing an exemplary environment 200 to which the present invention can be applied, in accordance with an embodiment of the present invention.

The environment 200 includes an Energy Management System (EMS) 210, a grid portion 220, a Photovoltaic (PV) portion 230, an Energy Storage System (ESS) portion 240, and various switching elements 250.

In an embodiment, the EMS 210 is configured to determine an ESS optimal size.

The grid portion 220 includes one or more power grids for distributing power to various loads/locations.

The PV portion 230 includes one or more PV devices for generating power. The generated power can be distributed by the grid portion 220.

The ESS portion 240 supplies stored power. The stored power can be distributed by the grid portion 220. The ESS portion 240 includes multiple batteries. In an embodiment, the multiple batteries have varying powers and capacities.

The switching elements 250 switch between various power sources, under the control of the EMS 210.

Various flowcharts follow hereinafter directed to various aspects of the present invention. It is to be appreciated that the ordering of the blocks/steps therein is essentially arbitrary unless a dependency exists (e.g., input A, input B, calculate C from A and B), as readily appreciated by one of ordinary skill in the art, given the teachings of the present invention provided herein, while maintaining the spirit of the present invention.

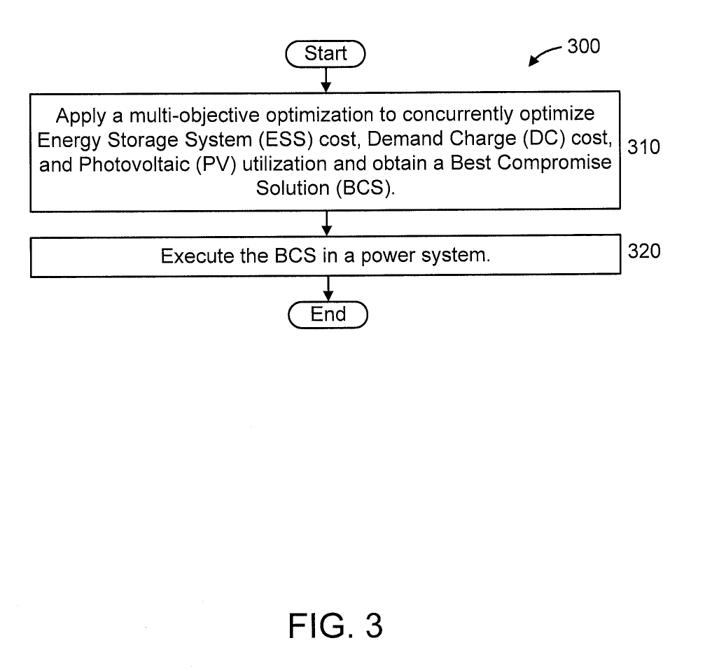

FIG. 3 is a flow diagram showing an exemplary method 300 for optimal sizing of energy storage units in demand charge management and PV utilization applications, in accordance with an embodiment of the present invention.

At block 310, apply a multi-objective optimization to concurrently optimize Energy Storage System (ESS) cost, Demand Charge (DC) cost, and Photovoltaic (PV) utilization and obtain a Best Compromise Solution (BCS). The optimization solves the multi-objective problem of optimize ESS cost, DC cost, and PV utilization in different time horizons, maps the results into a unique time horizon, and selects the best solution. The best solution can be a compromise solution based on user specified targets or some other criteria.

At block 820, execute the BCS in a power system.

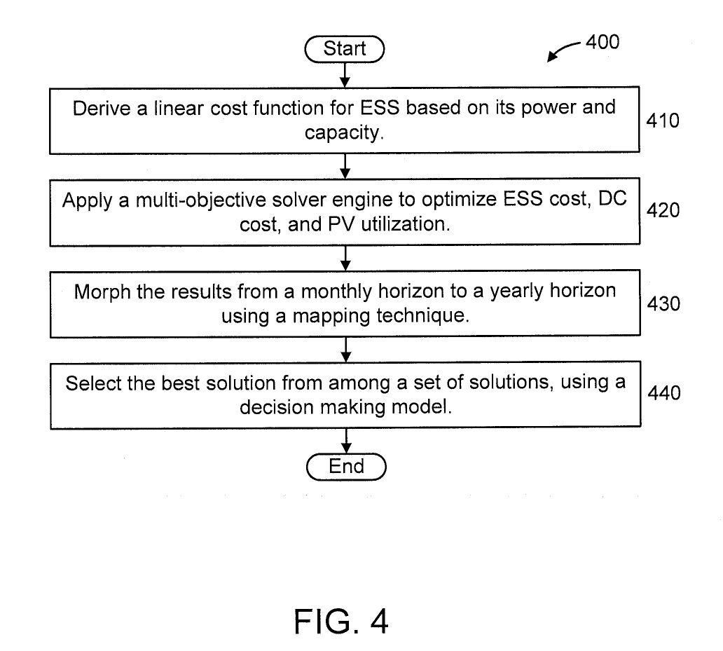

FIG. 4 is a flow diagram further showing block 310 of FIG. 3, in accordance with an embodiment of the present invention. In FIG. 4, block 310 is represented by blocks 410-440.

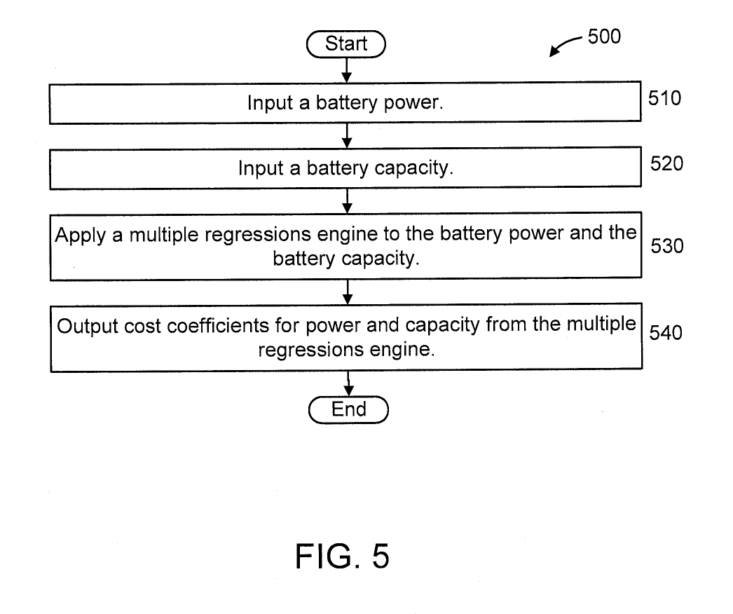

At block 410, derive a linear cost function for ESS based on its power and capacity. An exemplary methodology for performing block 410 is described below with respect to FIG. 5, in accordance with an embodiment of the present invention.

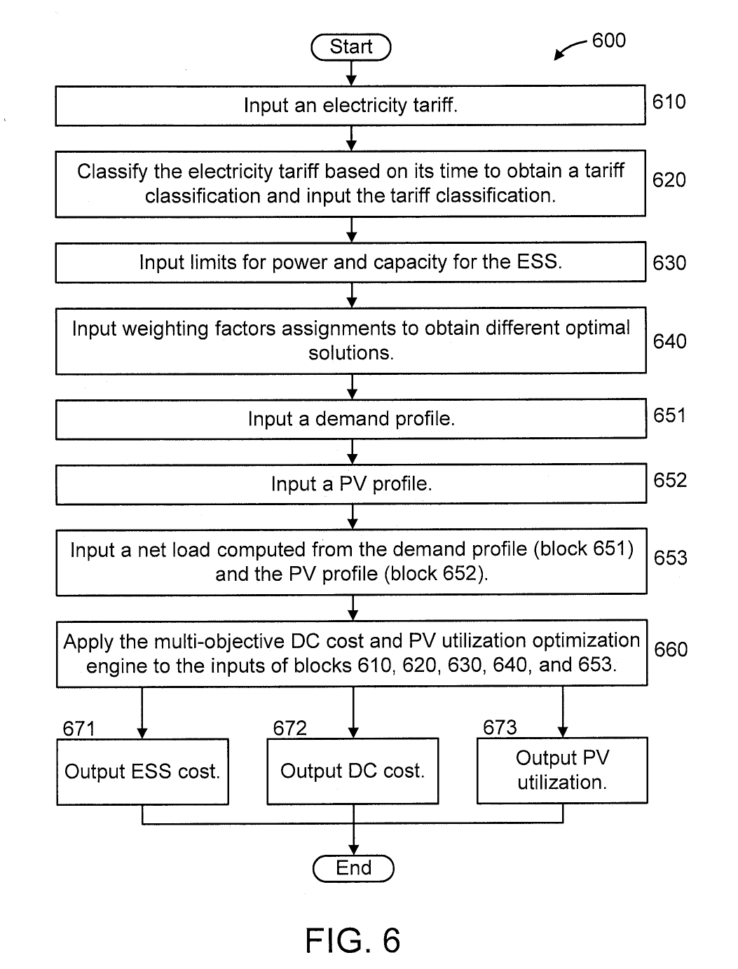

At block 420, apply a multi-objective solver engine to optimize ESS cost, DC cost, and PV utilization. An exemplary methodology for performing block 420 is described below with respect to FIG. 6, in accordance with an embodiment of the present invention.

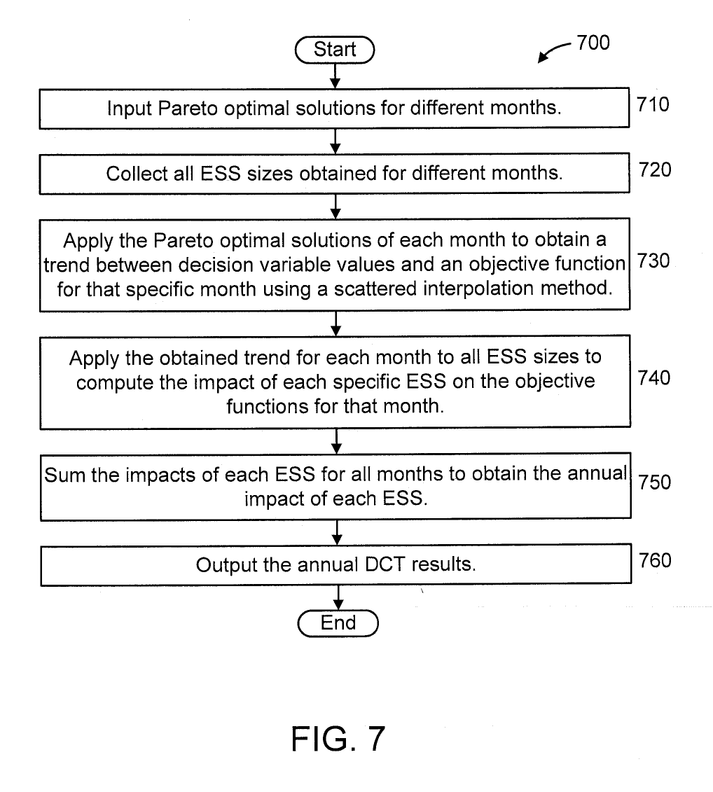

At block 430, morph the results from a monthly horizon to a yearly horizon using a mapping technique. An exemplary methodology for performing block 430 is described below with respect to FIG. 7, in accordance with an embodiment of the present invention.

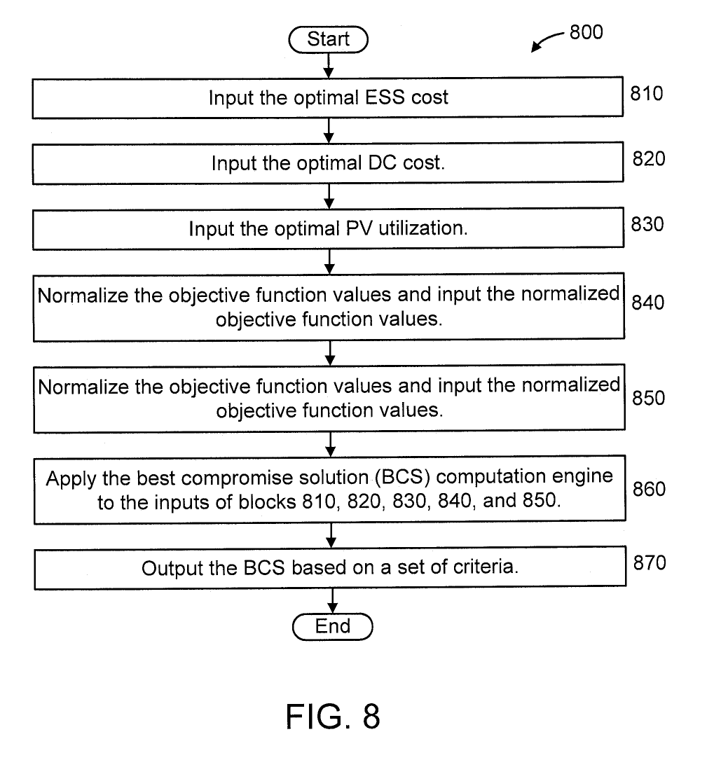

At block 440, select the best solution from among a set of solutions, using a decision making model. An exemplary methodology for performing block 440 is described below with respect to FIG. 8, in accordance with an embodiment of the present invention.

FIG. 5 is a flow diagram further showing block 410 of FIG. 4, in accordance with an embodiment of the present invention. In an embodiment, FIG. 5 can be considered to show how to derive a linear cost function for an ESS based on its power and capacity. In FIG. 5, block 410 is represented by blocks 510-540.

At block 510, input a battery power.

At block 520, input a battery capacity.

At block 530, apply a multiple regressions engine to the battery power and the battery capacity.

At block 540, output cost coefficients for power and capacity from the multiple regressions engine.

Further regarding FIG. 5, ESS costs corresponding to different sets of power and capacity can be used to obtain a linear cost function for the ESS system, based on its power and capacity. The output (block 540) can be a universal linear function which can compute the ESS cost based on its power and capacity.

FIG. 6 is a flow diagram an exemplary method 600 for multi-objective optimization for ESS cost, DC cost, and PV utilization, in accordance with an embodiment of the present invention.

At block 610, input an electricity tariff. The electricity tariff can be set by the utility providing the electricity. For example, the price for electricity may be X cents/kwhr when consumption is usually high, and Y cents/kwhr for other times, where X>Y. Hence, the electricity tariff represents the price of electricity from the utility at different time intervals.

At block 620, classify the electricity tariff based on its time to obtain a tariff classification and input the tariff classification.

At block 630, input limits for power and capacity for the ESS.

At block 640, input weighting factors assignments to obtain different optimal solutions.

At block 651, input a demand profile.

At block 652, input a PV profile.

At block 653, input a net load computed from the demand profile (block 651) and the PV profile (block 652).

At block 660, apply the multi-objective DC cost and PV utilization optimization engine to the inputs of blocks 610, 620, 630, 640, and 653. The demand profile (block 651) and PV profile (block 652) are not used by the engine, rather the net loaded computed therefrom is used by the engine.

At blocks 671, 672, and 673, output the ESS cost, the DC cost, and the PV utilization, respectively.

FIG. 7 is a flow diagram showing an exemplary method 700 for mapping to morph results from a monthly horizon to a yearly horizon, in accordance with an embodiment of the present invention.

At block 710, input Pareto optimal solutions for different months.

At block 720, collect all ESS sizes obtained for different months.

At block 730, apply the Pareto optimal solutions of each month to obtain a trend between decision variable values and an objective function for that specific month using a scattered interpolation method.

At block 740, apply the obtained trend for each month to all ESS sizes to compute the impact of each specific ESS on the objective functions for that month.

At block 750, sum the impacts of each ESS for all months to obtain the annual impact of each ESS.

At block 760, output the annual DCT results.

Further regarding FIG. 7, a trend is obtained (block 730) which shows the relationship between control variables (battery sizes) and objective functions for each month. Thereafter, the obtained trend would apply to all ESS sizes (obtained in different months) to compute the impact of each ESS size on the objective function of that specific month. These impacts are summed to show the impact of each ESS size on the objective function in an annual time frame.

FIG. 8 is a high-level block diagram showing a decision making model 800 for selecting a best compromise solution, in accordance with an embodiment of the present invention.

At block 810, input the optimal ESS cost.

At block 820, input the optimal DC cost.

At block 830, input the optimal PV utilization.

At block 840, normalize the objective function values and input the normalized objective function values.

At block 850, input weighting factors for the objectives.

At block 860, apply the best compromise solution (BCS) computation engine to the inputs of blocks 810, 820, 830, 840, and 850.

At block 870, output the BCS based on a set of criteria. The set of criteria can include a user's intentions.

Further regarding FIG. 8, the decision making model is processed to calculate the best compromise solution based on a set of criteria. In an embodiment, the criteria include user specified preferences. As is readily appreciated by one of ordinary skill in the art, the specific criteria will depend upon the implementation. The weighting factors can be selected by the user based on the criteria. The objective functions are normalized before being used by the decision making process in order to have the objective functions have the same range. The decision making process applies the weighting factors to the normalized objective functions in order to compute the BCS.

Also, regarding FIG. 8, a weighted sum optimization method is used to optimize ESS (battery) cost, DC cost, and PV utilization. The weighted sum optimization method dedicates a weight to each objective function in order to determine its importance. Then all objective functions are considered at the same time by summation of all objective functions multiplied by their corresponding weight factors. As mentioned above, all objective functions have to be in the same range, therefor all of the objective functions are normalized before being multiplied by their corresponding weight factors.

Further descriptions will now be given regarding various aspects of the present invention.

The present invention formulates the ESS sizing problem as a multi-objective linear programming optimization to determine the most economic size for power and energy of ESS in order to improve DC cost and PV utilization. It is notable that a linear cost function has been derived for ESS based on its power and energy capacity. This linear objective function has been optimized by weighted sum method along with DC cost and PV utilization objective functions.

Demand charge management inherently is a monthly optimization problem and the proposed approach obtains different optimal sizes of ESS, corresponds to different weights of objectives, for each month. However, ultimately users must install an ESS which operates for every month in a year. Toward this end an approach is presented to map the monthly Pareto fronts into a single yearly Pareto front.

A description will now be given regarding problem formulation, in accordance with an embodiment of the present invention.

Two different time windows are considered in this study to obtain the DC cost. These two windows are as follows:

Anytime DC: Defined as the maximum grid power over the entire time horizon multiplied by its rate.

Peak DC: Defined as the maximum grid power only during the peak time periods of a day multiplied by its rate.

The final DC cost is equal to the summation of these two components. Time windows and their corresponding rates vary for different seasons. The DC cost minimization objective function can be written as follows:

$${F}_{1} = {\sum }_{d = 1}^{{N}_{D}} {\sum }_{i = 1}^{24 \text{/} T} {C}_{DC}^{Anytime} \times max ( {P}_{grid}^{Purchase} ( i ) ) + {C}_{DC}^{Peak } \times max ( {P}_{grid}^{Peak} ( i ) ) + {C}_{ESS}^{Throughput} \times ( {P}_{ESS}^{Chg} ( i ) + {P}_{ESS}^{dischg} ( i ) ) \qquad ( 1 )$$

where F₁ is the sum of demand charge cost and ESS throughput cost. T is the optimization time-step in hour. C_{DC}^{Anytime}, and C_{DC}^{Peak} are the utility rates for Anytime DC, and Peak DC (in $/kW), respectively. P_{grid}^{Purchase}, and P_{grid}^{Peak} are power (in kW) purchased from the grid during Anytime DC, and Peak DC time windows, respectively. P_{ESS}^{chg} and P_{ESS}^{dischg} are ESS charge and discharge powers (in kW), respectively. C_{ESS}^{Throughput} is the ESS throughput cost in $ per kW, and N_{D} is the number of days in month.

The second objective function investigated in this paper is PV utilization. This objective can be optimized by minimizing the sell back energy to the grid over a monthly time horizon. Assuming a 15 minute time-step, this can be written as follows:

$${E}^{{sell}_{—} back} = {\sum }_{d = 1}^{{N}_{D}} {\sum }_{i = 1}^{24 \text{/} T} \frac{{P}_{grid}^{{sell}_{—} back} ( i , d )}{4} \qquad ( 2 )$$

The improvement in PV utilization through ESS operation can then be defined as follows:

$${F}_{2} = 1 - \frac{{E}_{{with}_{—} ESS}^{{sell}_{—} back}}{{E}_{{Without}_{—} ESS}^{{sell}_{—} back}} \qquad ( 3 )$$

ESS cost is defined as a function of its power and energy capacities as follows:

F₃=90×P_{ESS}+450×C_{ESS} (4)

The coefficients in (4) are obtained by applying R squared regression on different prices for different sizes of a sample ESS product in the market.

Constraints of the proposed problem are listed as follows:

SOC^{min}≤SOC(i)≤SOC^{max} (5)

P_{b}^{chg}(i),P_{b}^{dischg}(i)≤P_{b}^{max} (6)

SOC(i+1)=SOC(i)−αP_{ESS}^{dischg}(i)+αμP_{ESS}^{chg}(i) (7)

P_{grid}^{Purchase}(i)−P_{grid}^{Sell}(i)−P_{ESS}^{chg}(i)+P_{ESS}^{dischg}(i)=P_{d}(i)−P_{PV}(i) (8)

Equation (5) defines the State of Charge (SoC) limits, where SoC^{min} and SoC^{max} are the lower and upper bounds of ESS SoC, respectively. It is worth noting that the SoC^{max} is a variable in this study. Equation (6) defines the SoC based on energy stored in the ESS at the previous time-step and charge/discharge powers at each time-step, where a is a coefficient to convert kW to Ah, and μ is the roundtrip efficiency. Equation (7) ensures both ESS charge and discharge powers are always less than maximum ESS power (P_{ESS}^{max}). Equation (8) expresses the Supply-Demand balance in the system, where P_{grid}^{Sell}^{_}^{back}, P_{d}(i), and P_{PV}(i) are the sell back power to the grid, the active demand power, and the PV output power at i^{th} time interval, respectively. It is noteworthy that P_{ESS} and C_{ESS} in (4) are equal to P_{ESS}^{max} and SOC^{max}.

A description will now be given regarding finding monthly Pareto fronts, in accordance with an embodiment of the present invention.

The multi-objective optimization problem has been solved by weighted sum method to obtain the ESS optimal sizes for each month. The weighted sum method turns a set of objectives into a single one by multiplying each objective with a user supplied weight.

The Pareto front for multi-objective optimization of DC cost and ESS cost are obtained by optimizing equation (9) for each month. Similarly, the non-dominated solutions for PV utilization and ESS cost in each month are obtained by changing the weight factors in (10).

F_{MOOP}=ω₁F₁+ω₃F₃ (9)

F_{MOOP}=ω₂F₂+ω₃F₃ (10)

A description will now be provided regarding mapping monthly results to a yearly horizon, in accordance with an embodiment of the present invention.

Demand charge management is inherently a monthly optimization problem because of utilities billing cycle. This means that the optimal ESS size for DC management can vary by month. Therefore, it is necessary to come up with a procedure to calculate optimal ESS size for a year based on monthly optimization results.

To map monthly results into an annual Pareto front, first an optimal monthly DC cost function based on ESS power and energy capacity is estimated for each month from each monthly Pareto front. To estimate the optimal monthly DC cost function, a scattered interpolation approach has been employed in this study. The interpolation approach can be based on a multilevel B-splines or other method. These estimated DC cost functions for each month are then used to calculate optimal monthly DC cost for every ESS size in every monthly Pareto front of the year. Finally, optimal monthly DC costs are summed up to obtain the annual DC cost for every ESS size in the Pareto front.

A description will now be given regarding finding the best compromise solution, in accordance with an embodiment of the present invention.

There are different criterions that users can make decision based on to buy an ESS. These criterions include ESS cost, payback period, and the amount of annual saving that ESS can bring to users. The idea of “payback” is simple enough, namely you pay for an ESS system upfront, so you want to know how long it will take to get your money back. An ESS which yields a short payback period is typically a profitable one because subsequent years of having ESS result in pure revenue for the user. Conversely longer payback periods are typically not desirable for investment positions. However, making a decision to select a specific ESS size between differently sized ESSs cannot be done just by comparing the payback periods. Since smaller batteries, which are usually cheaper, have a lower payback period, they cannot bring significant saving to users. Therefore, having a compromise to select the optimal size of ESS seems to be crucial.

For users, it's worth calculating how the cost of the ESS compares with the saving they will make on their electricity bills. The saving is nothing but the difference between DC cost before and after installing an ESS as it is formulated in Equation (11). It is worth mentioning that ESS can profit from the energy arbitrage. However, energy arbitrage is not in the scope of this paper and it is not as profitable as the DC reduction.

Equation (11) is as follows:

Saving=DCCost^{WithoutESS}−DCCost^{WitESS} (11)

The payback period can be easily obtained by dividing the ESS cost by saving value as follows.

$$Payback Period = \frac{ESS Cost}{Saving} \qquad ( 12 )$$

Customers can make their decision based on their budget and saving expectation while they have specific payback period in their mind. There are a couple of choices for an ESS in the $80K range (or some other range can be used) while users can narrow down their choices by considering a specific amount of saving of, e.g., $9000 or some other amount. In this case, the ESS has a 6 years payback period time which seems to be a reasonable. In reality, the payback period will depend on a number of factors that may not be known in advance such as, for example, but not limited to: the future price of electricity; how your electricity use changes over time; the performance of the ESS over and above the warranted specifications, and so forth. However, the proposed method for calculating payback period gives a precise estimation to customers to select their desirable ESS.

Embodiments described herein may be entirely hardware, entirely software or including both hardware and software elements. In a preferred embodiment, the present invention is implemented in software, which includes but is not limited to firmware, resident software, microcode, etc. In an embodiment, various engines and models described herein can be implemented by software executed by one or more processing elements and/or can be implemented by circuitry such as Application Specific Integrated Circuits (ASICs), and so forth.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable medium such as a semiconductor or solid state memory, magnetic tape, a removable computer diskette, a random access memory (RAM), a read-only memory (ROM), a rigid magnetic disk and an optical disk, etc.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

Having described preferred embodiments of a system and method (which are intended to be illustrative and not limiting), it is noted that modifications and variations can be made by persons skilled in the art in light of the above teachings. It is therefore to be understood that changes may be made in the particular embodiments disclosed which are within the scope and spirit of the invention as outlined by the appended claims. Having thus described aspects of the invention, with the details and particularity required by the patent laws, what is claimed and desired protected by Letters Patent is set forth in the appended claims.

What is claimed is:

1. A system for controlling a distributed energy storage system (ESS) operatively coupled to one or more microgrids, the system comprising:
a memory for storing program code; and
a processor for running the program code to
respectively assign a first, a second, and a third set of weights to a first, a second, and a third objective function formulated to minimize an ESS cost, minimize a Demand Charge (DC) cost, and maximize a Photovoltaic utilization, respectively; and
execute a multi-objective ESS optimizing engine to obtain a set of different monthly-based optimal solutions for controlling the ESS by concurrently processing the first, the second, and the third objective functions using different ones of the weights from the first, the second, and the third set of weights.

2. The system of claim 1, wherein the first set of weights assigned to the first objective function formulated to minimize the ESS cost is determined by applying a multiple regressions engine to a battery power value and a battery capacity of the ESS.

3. The system of claim 1, wherein the multi-objective ESS optimizing engine obtains the set of different monthly-based optimal solutions by also concurrently processing a time-based electricity tariff.

4. The system of claim 1, wherein the multi-objective ESS optimizing engine obtains the set of different monthly-based optimal solutions by also concurrently processing an ESS power limit and an ESS capacity limit.

5. The system of claim 1, wherein the multi-objective ESS optimizing engine obtains the set of different monthly-based optimal solutions by also concurrently processing a net load computation derived from a DC profile and a PV profile.

6. The system of claim 1, wherein the processor is further configured to run code to
morph the set of different monthly-based solutions to a set of different yearly-based solutions by morphing monthly time horizons of the set of different monthly-based solutions to a yearly horizon; and
execute a best compromise solution computation engine to select a best compromise solution from among the set of different yearly-based solutions based on certain criteria.

7. The system of claim 6, further comprising controlling the ESS using the best compromise solution.

8. The system of claim 1, further comprising controlling the ESS using a best compromise solution derived from the set of different monthly-based optimal solutions.

9. The system of claim 8, wherein the best compromise solution is determined with respect to a yearly horizon derived from monthly horizons relating to the set of different monthly-based optimal solutions.

10. The system of claim 9, wherein the yearly horizon is derived using a scattered interpolation technique that obtains monthly trends relating to the objective functions versus decision variable values for the objective functions.

11. A computer-implemented method for controlling a distributed energy storage system (ESS) operatively coupled to one or more microgrids, the method comprising:
respectively assigning, by a processor, a first, a second, and a third set of weights to a first, a second, and a third objective function formulated to minimize an ESS cost, minimize a Demand Charge (DC) cost, and maximize a Photovoltaic utilization, respectively; and
executing, by the processor, a multi-objective ESS optimizing engine to obtain a set of different monthly-based optimal solutions for controlling the ESS by concurrently processing the first, the second, and the third objective functions using different ones of the weights from the first, the second, and the third set of weights.

12. The computer-implemented method of claim 11, wherein the first set of weights assigned to the first objective function formulated to minimize the ESS cost is determined by applying a multiple regressions engine to a battery power value and a battery capacity of the ESS.

13. The computer-implemented method of claim 11, wherein the multi-objective ESS optimizing engine obtains the set of different monthly-based optimal solutions by also concurrently processing a time-based electricity tariff.

14. The computer-implemented method of claim 11, wherein the multi-objective ESS optimizing engine obtains the set of different monthly-based optimal solutions by also concurrently processing an ESS power limit and an ESS capacity limit.

15. The computer-implemented method of claim 11, wherein the multi-objective ESS optimizing engine obtains the set of different monthly-based optimal solutions by also concurrently processing a net load computation derived from a DC profile and a PV profile.

16. The computer-implemented method of claim 11, wherein the processor is further configured to run code to
morph the set of different monthly-based solutions to a set of different yearly-based solutions by morphing monthly time horizons of the set of different monthly-based solutions to a yearly horizon; and
execute a best compromise solution computation engine to select a best compromise solution from among the set of different yearly-based solutions based on certain criteria.

17. The computer-implemented method of claim 16, further comprising controlling the ESS using the best compromise solution.

18. The computer-implemented method of claim 11, further comprising controlling the ESS using a best compromise solution derived from the set of different monthly-based optimal solutions.

19. The computer-implemented method of claim 18, wherein the best compromise solution is determined with respect to a yearly horizon derived from monthly horizons relating to the set of different monthly-based optimal solutions.

20. A computer program product for controlling a distributed energy storage system (ESS) operatively coupled to one or more microgrids, the computer program product comprising a non-transitory computer readable storage medium having program instructions embodied therewith, the program instructions executable by a computer to cause the computer to perform a method comprising:
respectively assigning, by a processor of the computer, a first, a second, and a third set of weights to a first, a second, and a third objective function formulated to minimize an ESS cost, minimize a Demand Charge (DC) cost, and maximize a Photovoltaic utilization, respectively; and
executing, by the processor, a multi-objective ESS optimizing engine to obtain a set of different monthly-based optimal solutions for controlling the ESS by concurrently processing the first, the second, and the third objective functions using different ones of the weights from the first, the second, and the third set of weights.
